(19) United States
(12) Patent Application Publication
(10) Pub. No.: US 2013/0284219 A1
(43) Pub. Date: Oct. 31, 2013

(54) APPARATUS FOR CLEANING A HOT DIP GALVANIZED STEEL SHEET

(71) Applicant: JFE STEEL CORPORATION, Tokyo (JP)

(72) Inventors: Satoshi YONEDA, Chiba (JP); Takahiro SUGANO, Chiba (JP)

(21) Appl. No.: 13/910,664

(22) Filed: Jun. 5, 2013

Related U.S. Application Data
(62) Division of application No. 12/086,438, filed on Jun. 12, 2008.

(30) Foreign Application Priority Data
Jan. 26, 2006 (JP) 2006-017745

(51) Int. Cl. B08B 3/02

(52) U.S. Cl. CPC B08B 3/022
USPC 134/64 R

(57) ABSTRACT

An apparatus for cleaning a hot dip galvanized steel sheet including: a cleaning liquid spray nozzle which sprays a cleaning liquid to both surfaces of a strip-shaped hot dip galvanized steel sheet which was treated by surface oxidation and which is continuously traveling; and a pure water spray nozzle which sprays pure water to both surfaces of the hot dip galvanized steel sheet a position where the hot dip galvanized steel sheet travels 1 second or more after being sprayed with the cleaning liquid.

### CROSS-REFERENCE TO RELATED APPLICATIONS

This application is a divisional application of application Ser. No. 12/086,438 filed Jun. 12, 2008, which is a United States national phase application under 35 USC 371 of International application PCT/JP2007/051321 filed Jan. 22, 2007. The entire contents of each of application Ser. No. 12/086,438 and International application PCT/JP2007/051321 are hereby incorporated by reference herein.

### TECHNICAL FIELD

The present invention relates to a method and an apparatus for cleaning a steel sheet which was prepared by hot dip galvanizing on a strip-shaped steel sheet, and by applying alloying and temper rolling, further by applying surface oxidation using an acidic solution, (hereinafter referred to as “the hot dip galvanized steel sheet”).

### BACKGROUND ART

On applying hot dip galvanization to a strip-shaped steel sheet, the steel sheet which was treated by pickling for descaling, followed by rolling in a rolling mill to a specified thickness is annealed in an annealing furnace, and further is transferred to a molten zinc bath. FIG. 3 illustrates the process of common hot dip galvanizing line on and after the molten zinc bath. The steel sheet travels in the arrow “a” direction.

For applying hot dip galvanization to a steel sheet 1a, the steel sheet 1a is immersed in a molten zinc bath 2, as illustrated in FIG. 3. Zinc in molten state is held in the molten zinc bath 2, (hereinafter referred to as “the zinc bath”). During the travel of the steel sheet 1a in the zinc bath, zinc adheres to both surfaces of the steel sheet 1a.

Then, the steel sheet 1a is sent from the molten zinc bath 2 to an alloying furnace 3, where the steel sheet 1a is subjected to alloying treatment. The alloying treatment is a heat treatment to enhance the alloying reaction between the steel base material of the steel sheet 1a and the zinc adhered to the steel sheet 1a, thus forming a zinc-plating layer having excellent adhesion.

The steel sheet 1a after leaving the alloying furnace 3 is cooled before an interim looper 4 while being adjusted in the tension thereon, and is further sent to a temper rolling mill 5 to undergo temper rolling (what is called the “skin pass”). The temper rolling is a rolling to apply a light reduction of about 0.6 to about 3% of reduction in thickness to deform only in the vicinity of the surface of steel sheet 1a, thereby adjusting the surface properties (such as surface roughness) of the steel sheet 1a. The reduction in thickness is defined by the value derived from eq. (1):

Reduction in thickness (%)=100×(t₁−t₂)/t₁ (1)

where, t₁ is the thickness before temper rolling (mm), and t₂ is the thickness after temper rolling (mm).

Then, the steel sheet 1a is fed from the temper rolling mill 5 to a surface oxidation apparatus 6 to receive surface oxidation treatment. The surface oxidation treatment is given to bring both surfaces of the steel sheet 1a into contact with an acidic solution, thus to form an oxide film on the surface of the plating layer. The steel sheet which was treated by the surface oxidation is hereinafter referred to as “the hot dip galvanized steel sheet 1b”.

With thus covering the plating layer with the oxide film, the sliding property of the hot dip galvanized steel sheet 1b on working (for example on press-forming) into products having varieties of shapes is improved. Since, however, the hot dip galvanized steel sheet 1b which is processed from the surface oxidation apparatus 6 has acidic solution adhered thereto, both surfaces of the hot dip galvanized steel sheet 1b are cleaned in a rinse tank 7 by washing off the acidic solution, and the hot dip galvanized steel sheet 1b is further dried in a drier 8.

The cleaned hot dip galvanized steel sheet 1b enters an outlet looper 9, where the tension thereon is adjusted, and enters an oiler 10, where a rust-preventive is applied onto the surfaces thereof, followed by coiling the hot dip galvanized steel sheet 1b by a coiler 11.

As of the conventional hot dip galvanizing line described above, FIG. 4 shows a part-enlarged view ranging from the surface oxidation apparatus 6 to the rinse tank 7. The hot dip galvanized steel sheet travels in the arrow “a” direction.

The surface oxidation apparatus 6 brings the surface of the hot dip galvanizing on the steel sheet 1a into contact with the acidic solution. As shown in FIG. 4, for example, acidic solution spray nozzles 12 to spray the acidic solution 13 are arranged therein.

The hot dip galvanized steel sheet 1b on which the acidic solution was sprayed in the surface oxidation apparatus 6 is sent to the rinse tank 7. To assure a period of time necessary to form the oxide film on the surface of the plating layer at a sufficient thickness, the distance between the surface oxidation apparatus 6 and the rinse tank 7 is determined to a specific length. For example, by controlling the traveling period of time between the surface oxidation apparatus 6 and the rinse tank 7, the thickness of the oxide film can reach to 10 nm (nanometer) or larger. Japanese Patent Laid-Open Nos. 2002-256448 and 2003-306781 disclose that the covering a plating layer with an oxide film having 10 nm or larger thickness improves the sliding property of hot dip galvanized steel sheet 1b, thus preventing damages and peeling of plating layer on working (press-forming and the like) into products having varieties of shapes.

The rinse tank 7 arranges nozzles therein to spray a cleaning water 14. By spraying the cleaning water 14 to the hot dip galvanized steel sheet 1b, the acidic solution adhered to the hot dip galvanized steel sheet 1b is removed. Sole spraying of the cleaning water 14 is, however, difficult to completely wash off the acidic solution adhered to the hot dip galvanized steel sheet 1b. Although investigations about the issue are given including addition of chemicals to the cleaning water 14, there are left improvement issues in terms of composition and adding amount of chemicals.

Remained acidic solution on the surface of the hot dip galvanized steel sheet 1b leads to corrosion of the plating layer by acid, which results in not only the deterioration of appearance but also the damages and peeling of plating layer, thereby decreasing the product yield.

An object of the present invention is to solve the above problems and to provide a cleaning method and a cleaning apparatus to efficiently and fully wash off the acidic solution adhered to the surface of a hot dip galvanized steel sheet which was treated by surface oxidation.

### DISCLOSURE OF THE INVENTION

The present invention provides a method for cleaning hot dip galvanized steel sheet by steps of bringing a strip-shaped hot dip galvanized steel sheet, treated by surface oxidation in advance, into contact with a cleaning liquid for 1 second or more, and then bringing the hot dip galvanized steel sheet into contact with pure water, while continuously transferring the hot dip galvanized steel sheet.

According to the cleaning method of the present invention, the contact with the cleaning liquid and the contact with the pure water are preferably conducted in a single cleaning tank. Furthermore, it is preferable that a diluted cleaning liquid prepared by mixing the cleaning liquid with the pure water in the single cleaning tank is stored in a circulation tank, and that the hot dip galvanized steel sheet is further brought into contact with the diluted cleaning liquid in the circulation tank, while utilizing the diluted cleaning liquid by recirculating thereof. In addition, it is more preferable that the contact of the diluted cleaning liquid is given at a position after a position of beginning the contact with the cleaning liquid and at a position before a position of beginning the contact with the pure water.

For any of the above cleaning methods, the cleaning liquid preferably contains P, and specifically the P concentration in the cleaning liquid is preferably in a range from 4 to 70 ppm by mass.

The present invention provides an apparatus for cleaning hot dip galvanized steel sheet, which has: cleaning liquid spray nozzles which spray a cleaning liquid to both surfaces of a strip-shaped hot dip galvanized steel sheet which was treated by surface oxidation and which is continuously traveling; and pure water spray nozzles which spray pure water to both surfaces of the hot dip galvanized steel sheet at a position where the hot dip galvanized steel sheet travels 1 second or more after being sprayed with the cleaning liquid.

The apparatus of the present invention preferably has an inverting roller to invert a traveling direction of the hot dip galvanized steel sheet, at a position between the spraying position of the cleaning liquid spray nozzles and the spraying position of the pure water spray nozzles.

Both of above apparatuses preferably arrange both the cleaning liquid spray nozzles and the pure water spray nozzles in a single cleaning tank.

Any of the above apparatuses preferably further has a circulation tank which stores a diluted cleaning liquid prepared by mixing the cleaning liquid with the pure water in the single cleaning tank, and diluted cleaning liquid spray nozzles which spray the diluted cleaning liquid in the circulation tank to both surfaces of the hot dip galvanized steel sheet. For these apparatuses, it is preferable that the diluted cleaning liquid spray nozzles are located between a spraying position of the cleaning liquid spray nozzles and a spraying position of the pure water spray nozzles.

The present invention provides a method for cleaning strip-shaped hot dip galvanized steel sheet while continuously transferring a strip-shaped hot dip galvanized steel sheet which was treated by surface oxidation, which method has steps of: bringing the hot dip galvanized steel sheet into contact with a cleaning liquid for 1 second or more; and then bringing the hot dip galvanized steel sheet into contact with pure water.

### BRIEF DESCRIPTION OF THE DRAWINGS

FIG. 1 illustrates a cross sectional view of an example of the cleaning apparatus according to the present invention.

FIG. 2 illustrates a cross sectional view of another example of the cleaning apparatus according to the present invention.

FIG. 3 illustrates an arrangement of an example of hot dip galvanizing apparatus.

FIG. 4 illustrates a part of conventional process ranging from the surface oxidation apparatus 6 to the cleaning tank 7.

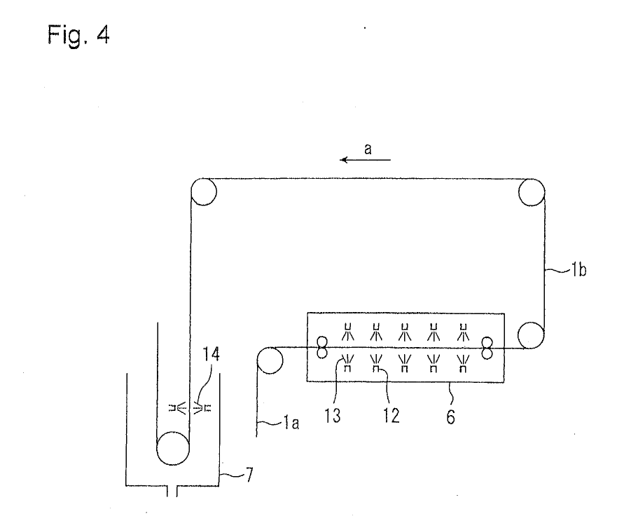

### BEST MODE FOR CARRYING OUT THE INVENTION

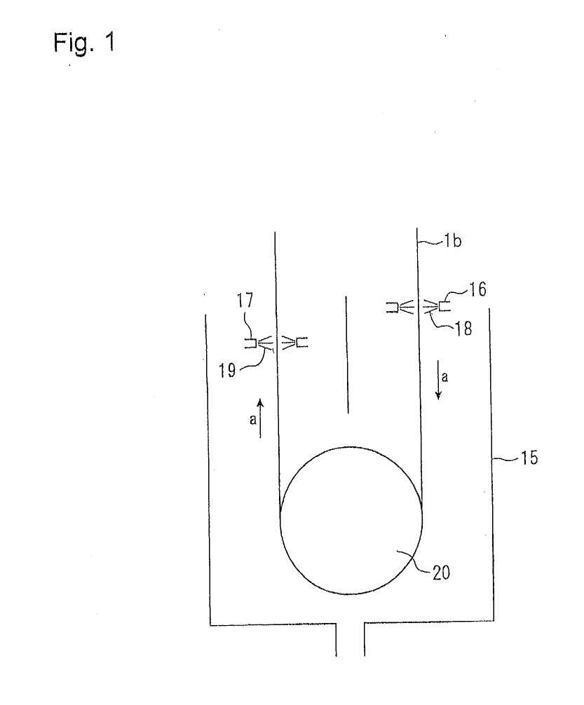

FIG. 1 illustrates a cross sectional view of an example of the cleaning apparatus according to the present invention. According to the present invention, it is possible that the tank where the cleaning liquid is sprayed and the tank where the pure water is sprayed are separately installed to conduct cleaning of a hot dip galvanized steel sheet. The embodiment described herein adopts an example of illustration in FIG. 1, where the spray of cleaning liquid and the spray of pure water are given in a single tank, (hereinafter referred to as “the cleaning tank”). The hot dip galvanized steel sheet 1b travels in the arrow “a” direction.

The hot dip galvanized steel sheet 1b prepared by hot dip galvanizing on a strip-shaped steel sheet 1a, by applying treatment of alloying and temper rolling, followed by surface oxidation using an acidic solution is sent to a cleaning tank 15. The cleaning tank 15 has cleaning liquid spray nozzles 16 and pure water spray nozzles 17. The pure water nozzles 17 are located at a position where the hot dip galvanized steel sheet travels 1 second or more after being sprayed with the cleaning liquid. The cleaning liquid spray nozzles 16 spray a cleaning liquid 18 having cleaning function to both surfaces of the hot dip galvanized steel sheet 1b, and the pure water spray nozzles 17 spray pure water to both surfaces of the hot dip galvanized steel sheet 1b. The pure water in the present invention is distilled water, ion-exchanged water, industrial clean water, and the like, which are free from P.

The cleaning tank 15 preferably has an inverting roller 20 which inverts the travel direction of the hot dip galvanized steel sheet 1b. The inverting roller 20 inverts the traveling direction of the hot dip galvanized steel sheet 1b, (in the direction from bottom to top in the cleaning tank 15), after the cleaning liquid 18 is sprayed to the hot dip galvanized steel sheet 1b traveling from top to bottom of the cleaning tank 15, thereby allowing the cleaning liquid 18 at the lowermost position, (hereinafter referred to as “the inverting bottom end”), to drip from the hot dip galvanized steel sheet 1b. Accordingly, the hot dip galvanized steel sheet 1b keeps contact with the cleaning liquid 18 during a traveling period of from the spray of the cleaning liquid 18 to the dripping.

According to the present invention, it is preferable that the center axes of the opposing cleaning liquid spray nozzles 16, (hereinafter referred to as “the cleaning liquid spray position”), are aligned, and that the inverting roller 20 is located at-a position assuring 1 second or more of the time for traveling the hot dip galvanized steel sheet 1b from the cleaning liquid spray position to the inverting bottom end, thereby ensuring 1 second or longer time of contacting the hot dip galvanized steel sheet 1b with the cleaning liquid 18. If the contact time is 1 second or more, the cleaning effect of the cleaning liquid 18 is fully attained.

It is preferable that the period of time for the hot dip galvanized steel sheet 1b to travel from the cleaning liquid spray position to the inverting bottom end, (or the time contacting with the cleaning liquid 18), is 10 seconds or less. If the above time becomes excessively large, a long cleaning tank 15 is required, and the cleaning liquid 18 dries on the surface of the hot dip galvanized steel sheet 1b to deposit the cleaning liquid ingredients, which deteriorates the appearance of the hot dip galvanized steel sheet 1b.

By limiting the time of contacting the hot dip galvanized steel sheet 1b with the cleaning liquid 18 to 1 second or more, preferably from 1.5 to 8 seconds, the concentration of the cleaning liquid 18 can be decreased, and the acidic solution adhered to the hot dip galvanized steel sheet 1b can be washed off.

The kind of the cleaning liquid 18 is not specifically limited if only it has the cleaning performance. It is, however, preferable that the cleaning liquid 18 contains an alkaline ingredient to neutralize and wash off the acidic solution adhered to the hot dip galvanized steel sheet 1b, and specifically preferred cleaning liquid 18 is the one containing P. For the cleaning liquid 18 containing P, a preferable concentration of P in the cleaning liquid 18 is from 4 to 70 ppm by mass. If the P concentration is 4 ppm by mass or more, the acidic solution adhered to the hot dip galvanized steel sheet 1b can be fully washed off. The P concentration of 70 ppm by mass or less considerably reduces the remaining amount of the cleaning liquid ingredients even after the pure water spray 19 described later, and the appearance of the hot dip galvanized steel sheet 1b is not deteriorated.

After the hot dip galvanized steel sheet 1b is brought into contact with the cleaning liquid 18, and further drips the cleaning liquid 18 therefrom at the inverting bottom end, the hot dip galvanized steel sheet 1b is brought into contact with the pure water 19 to remove the remained cleaning liquid 18.

According to the present invention, although the center axes of the opposing pure water spray nozzles 17, (hereinafter referred to as “the pure water spray position”), are aligned, the period of time for traveling the hot dip galvanized steel sheet 1b from the inverting bottom end to the pure water spray position is not specifically limited. It is, however, preferable that the position of the pure water spray is determined considering that the pure water 18 is sprayed before the cleaning liquid 18 remained on the hot dip galvanized steel sheet 1b is dried.

The cleaning liquid 18 and the pure water 19, sprayed to the hot dip galvanized steel sheet 1b in the cleaning tank 15 drop onto the bottom of the cleaning tank 15, which are then successively discharged to enter a separately installed tank, (hereinafter referred to as “the circulation tank”). That is, the cleaning liquid 18 and the pure water 19 are not held in the cleaning tank 15 but are held in the circulation tank as a mixture of cleaning liquid 18 diluted by pure water 19, (hereinafter referred to as “the diluted cleaning liquid”). If the diluted cleaning liquid is subjected to wastewater treatment to remove toxic substances before discharging, the environment is not polluted.

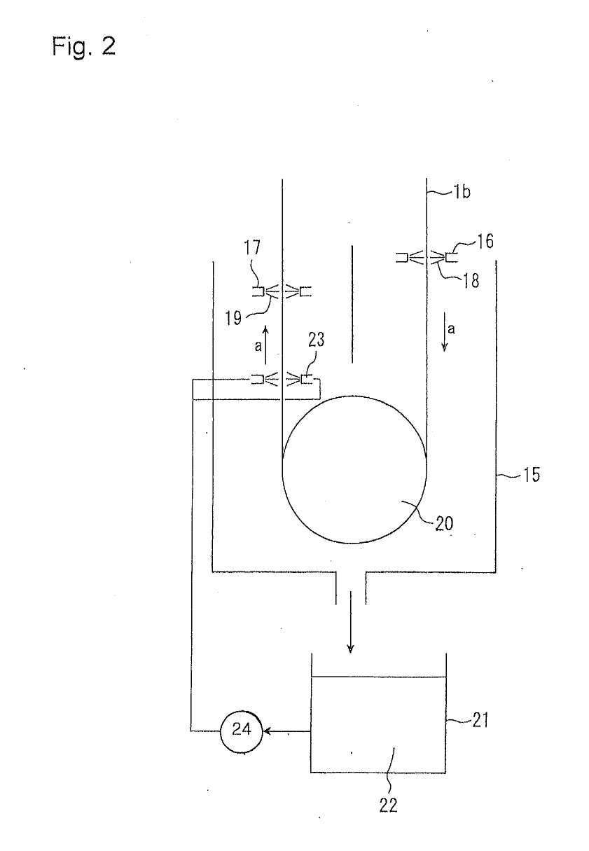

Furthermore, the inventors of the present invention derived a finding that, on washing off the acidic solution adhered to the hot dip galvanized steel sheet 1b, the reuse of the diluted cleaning solution improves the cleaning effect. An example of the cleaning apparatus is illustrated in FIG. 2. The hot dip galvanized steel sheet travels in the arrow “a” direction.

As illustrated in FIG. 2, as an example, the diluted cleaning liquid 22 held in the circulation tank 21 is recirculated by a pump 24 or the like, and is further sprayed on both surfaces of the hot dip galvanized steel sheet 1b at an interim position between the position for initiating the contact with the cleaning liquid and the position for initiating the contact with the pure water, thus increases the cleaning effect. That is, adding to the cleaning liquid ingredients existing in the cleaning liquid 18, the low concentration cleaning liquid ingredients existing in the diluted cleaning liquid 22 are utilized to wash off the acidic solution adhered to the hot dip galvanized steel sheet 1b. At the cleaning step, the diluted cleaning liquid spray nozzles 23 spraying the diluted cleaning liquid 22 are arranged to align their center axes at their opposing positions, (hereinafter referred to as “the diluted cleaning liquid spray position”).

The diluted cleaning liquid spray position is preferably located between the position for spraying the cleaning liquid and the position for spraying the pure water, and specifically preferable position is between the reverting bottom end and the pure water spray position because the spray of the diluted cleaning liquid 22 after dripping the cleaning liquid 18 effectively performs the cleaning effect of the cleaning liquid ingredients.

### EXAMPLES

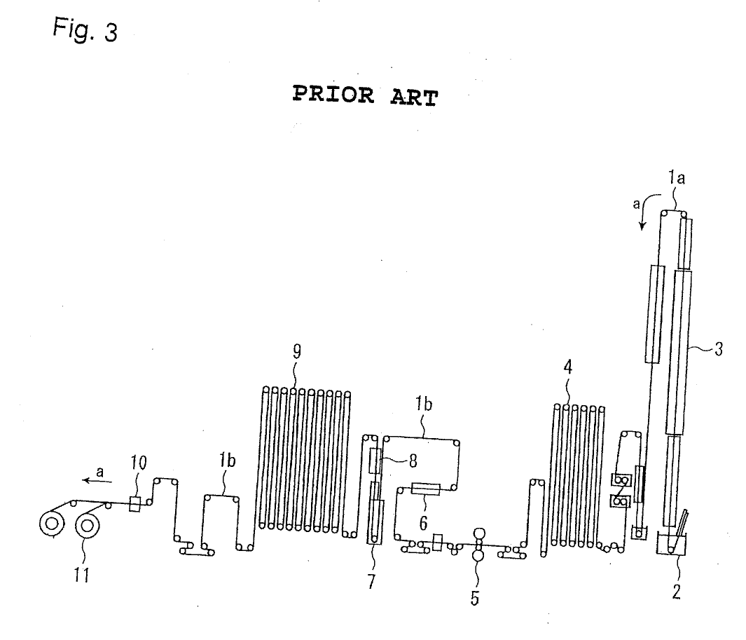

The hot dip galvanized steel sheet 1b was prepared by installing the cleaning tank 15 shown in FIG. 1 instead of the rinse tank 7 in the hot dip galvanization line shown in FIG. 3. The inverting roller 20 in the cleaning tank 15 was located so as the hot dip galvanized steel sheet 1b to take 2.5 seconds of travel from the cleaning liquid spray position to the inverting bottom end. The cleaning liquid 18 contained P at a P concentration of 14 ppm by mass, an injection pressure of 0.15 MPa, and a flow rate of 5 m³/hr. The pure water 19 was industrial clean water which was sprayed at a position so as the hot dip galvanized steel sheet 1b to take 2.5 seconds of travel from the inverting bottom end to the pure water spray position at an injection pressure of 0.15 MPa and a flow rate of 10 m³/hr. The example was named the Example 1 of the Invention.

The hot dip galvanized steel sheet 1b was prepared by installing the cleaning tank 15 shown in FIG. 2 instead of the rinse tank 7 in the hot dip galvanization line shown in FIG. 3. The positions of the inverting roller 20, the cleaning liquid spray nozzles 16, and the pure water spray nozzles 17 in the cleaning tank 15, and the conditions for spraying the cleaning liquid and the pure water were the same to those in the Example 1, so that their descriptions are not given. The diluted cleaning liquid 22 was sprayed so as the hot dip galvanized steel sheet 1b to take 2.1 second of travel from the inverting bottom end to the diluted cleaning liquid spray position at an injection pressure of 0.20 MPa and a flow rate of 20 m³/hr. The example was named the Example 2 of the Invention.

Conventionally the hot dip galvanized steel sheet 1b was manufactured by using the rinse tank 7 in the hot dip galvanizing line given in FIG. 3. The rinse tank 7 used industrial clean water as the cleaning water 14 at an injection pressure of 0.10 MPa and a flow rate of 10 m³/hr. The example was named the Conventional Example.

For each of the Examples 1 and 2 of the Invention and the Conventional Example, the cleaned state on the hot dip galvanized steel sheet 1b was determined. The water-wetting rate calculated from eq. (2) was adopted as an index of the cleaned state. Higher value of water-wetting rate (%) indicates better cleaning result.

Water-wetting rate (%)=[Water-wetting surface area (mm²)]/[Sample surface area (mm²)] (2)

The water-wetting rate is defined by the following. A rust preventive (Nox-Rust 550KH, manufactured by Nihon Parkerizing Co. , Ltd.) was applied onto a sample, after cleaning, at a rate of 1900 mg/m². The sample was then immersed in a degreasing liquid (FC-E2011, manufactured by Nihon Parkerizing Co., Ltd.) for 2 minutes. Further the sample was cleaned by pure water. Then, the area rate of the water-wetted portion was determined by visual observation, which area rate is adopted as the water-wetting rate.

The observation gave the water-wetting rate of 80% for the Example 1 of the Invention, 85% for the Example 2 of the Invention, while giving 70% for the Conventional Example.

### INDUSTRIAL APPLICABILITY

The present invention allows efficiently and fully washing off the acidic solution adhered to the surface of the hot dip galvanized steel sheet after treating by the surface oxidation, thus the present invention contributes to the industries.

1. An apparatus for cleaning a hot dip galvanized steel sheet comprising: a cleaning liquid spray nozzle which sprays a cleaning liquid to both surfaces of a strip-shaped hot dip galvanized steel sheet which was treated by surface oxidation and which is continuously traveling; and a pure water spray nozzle which sprays pure water to both surfaces of the hot dip galvanized steel sheet at a position where the hot dip galvanized steel sheet travels 1 second or more after being sprayed with the cleaning liquid.

2. The apparatus for cleaning a hot dip galvanized steel sheet according to claim 1, further comprising an inverting roller to invert a traveling direction of the hot dip galvanized steel sheet, at a position between the spraying position of the cleaning liquid spray nozzle and the spraying position of the pure water spray nozzle.

3. The apparatus for cleaning a hot dip galvanized steel sheet according to claim 1, wherein both the cleaning liquid spray nozzle and the pure water spray nozzle are arranged in a single cleaning tank.

4. The apparatus for cleaning a hot dip galvanized steel sheet according to claim 3, further comprising: a circulation tank which stores a diluted cleaning liquid prepared by mixing the cleaning liquid with the pure water in the single cleaning tank; and a diluted cleaning liquid spray nozzle which sprays the diluted cleaning liquid in the circulation tank to both surfaces of the hot dip galvanized steel sheet.

5. The apparatus for cleaning a hot dip galvanized steel sheet according to claim 4, wherein the diluted cleaning liquid spray nozzle is located between a spraying position of the cleaning liquid spray nozzle and a spraying position of the pure water spray nozzle.
